(19) United States
(12) Patent Application Publication
(10) Pub. No.: US 2024/0316754 A1
(43) Pub. Date: Sep. 26, 2024

(54) AMR-Cart Attachment System

(71) Applicant: Black-I Robotics, Inc., Tyngsboro, MA (US)

(72) Inventors: Brian T. Hart, Bedford, MA (US); Mischa deRuijter, Harvard, MA (US)

(21) Appl. No.: 18/614,353

(22) Filed: Mar. 22, 2024

Related U.S. Application Data
(60) Provisional application No. 63/491,893, filed on Mar. 23, 2023.

(51) Int. Cl. B25J 5/00; B25J 19/00

(52) U.S. Cl. CPC B25J 5/007; B25J 19/007

(57) ABSTRACT

A multi-axis attachment system including: a first attachment subsystem configured to be coupled to an autonomous mobile robot and including one or more primary latching assemblies; and a second attachment subsystem configured to be coupled to a robot accessory mounting cart and including one or more secondary latching assemblies; wherein the one or more secondary latching assemblies are configured to releasably engage the one or more primary latching assemblies to effectuate the three-axis releasable coupling of the robot accessory mounting cart and the autonomous mobile robot.

### RELATED APPLICATION(S)

This application claims the benefit of the following: U.S. Provisional Application No. 63/491,893, filed on 23 Mar. 2023, the entire contents of which are incorporated herein by reference.

### TECHNICAL FIELD

This disclosure relates to attachment systems and, more particularly, to attachment systems for releasably coupling a cart to an autonomous mobile robot.

### BACKGROUND

Autonomous Mobile Robots (AMRs), machines designed to perform tasks with high degrees of autonomy, have been evolving for decades. The concept of a machine capable of performing tasks without human intervention traces back to the early 20th century, with significant advancements occurring during the latter half of the century. Initially, these robots were simple, performing basic tasks in controlled environments, such as manufacturing lines. However, with the advent of computer technology, artificial intelligence (AI), and robotics in the latter 20th and early 21st centuries, the capabilities and applications of autonomous robots expanded dramatically. Autonomous Mobile Robots (AMRs) may include both automated guided vehicles and autonomous mobile robots. Automated guided vehicles are mobile robots that follow fixed paths or tracks for material transportation, typically requiring infrastructure changes like magnetic tapes or wires, wherein autonomous mobile robots are mobile robots that operate autonomously and can navigate in an uncontrolled environment without the need for fixed paths or tracks.

The integration of carts onto AMRs with the capability for easy swapping of attachments leverages a modular design principle, significantly enhancing the versatility and efficiency of these robots across various applications. The scalability of this system ensures that as operational needs evolve, new carts can be designed and integrated without necessitating significant modifications to the existing robot fleet, safeguarding investments in robotic systems against future changes in demand or application. By prioritizing compatibility, ease of use, and safety in design, and by integrating software capable of dynamically assigning robots to tasks based on their current configuration, this innovative approach to AMR design marks a significant advancement towards creating adaptable, efficient automated systems suitable for a broad spectrum of industries.

### SUMMARY OF DISCLOSURE

In one implementation, a multi-axis attachment system includes: a first attachment subsystem configured to be coupled to an autonomous mobile robot and including one or more primary latching assemblies; and a second attachment subsystem configured to be coupled to a robot accessory mounting cart and including one or more secondary latching assemblies; wherein the one or more secondary latching assemblies are configured to releasably engage the one or more primary latching assemblies to effectuate the three-axis releasable coupling of the robot accessory mounting cart and the autonomous mobile robot.

One or more of the following features may be included. The robot accessory mounting cart may be configured to receive one or more accessories configured to work with the autonomous mobile robot. The one or more accessories may include a robotic arm assembly. The one or more accessories may include a monitoring system. The robot accessory mounting cart may include one or more outrigger wheels. The primary latching assemblies and/or the secondary latching assemblies may include one or more female latching receptacles configured to receive one or more male latching appendages. The primary latching assemblies and/or the secondary latching assemblies may include one or more male latching appendages configured to be positioned within the one or more female latching receptacles. The primary latching assemblies and/or the secondary latching assemblies may include one or more manually-operated latching assemblies. The primary latching assemblies and/or the secondary latching assemblies may include one or more automatically-operated latching assemblies. The multi-axis attachment system may be configured to locate the robot accessory mounting cart on top of the autonomous mobile robot in the XY-plane. The multi-axis attachment system may be configured to lock the robot accessory mounting cart on top of the autonomous mobile robot in the X-axis.

In another implementation, a multi-axis attachment system includes: a first attachment subsystem configured to be coupled to an autonomous mobile robot and including one or more primary latching assemblies; and a second attachment subsystem configured to be coupled to a robot accessory mounting cart and including one or more secondary latching assemblies; wherein: the one or more secondary latching assemblies are configured to releasably engage the one or more primary latching assemblies to effectuate the three-axis releasable coupling of the robot accessory mounting cart and the autonomous mobile robot, and the robot accessory mounting cart is configured to receive one or more accessories configured to work with the autonomous mobile robot.

One or more of the following features may be included. The one or more accessories may include a robotic arm assembly. The one or more accessories may include a monitoring system. The robot accessory mounting cart may include one or more outrigger wheels. The primary latching assemblies and/or the secondary latching assemblies may include one or more female latching receptacles configured to receive one or more male latching appendages. The primary latching assemblies and/or the secondary latching assemblies may include one or more male latching appendages configured to be positioned within the one or more female latching receptacles.

In one implementation, a multi-axis attachment system includes: a first attachment subsystem configured to be coupled to an autonomous mobile robot and including one or more primary latching assemblies; and a second attachment subsystem configured to be coupled to a robot accessory mounting cart and including one or more secondary latching assemblies; wherein: the multi-axis attachment system is configured to locate the robot accessory mounting cart on top of the autonomous mobile robot in the XY-plane, and the multi-axis attachment system is configured to lock the robot accessory mounting cart on top of the autonomous mobile robot in the X-axis.

One or more of the following features may be included. The robot accessory mounting cart may be configured to receive one or more accessories configured to work with the autonomous mobile robot. The one or more accessories may include a robotic arm assembly. The one or more accessories may include a monitoring system. The primary latching assemblies and/or the secondary latching assemblies may include one or more manually-operated latching assemblies. The primary latching assemblies and/or the secondary latching assemblies may include one or more automatically-operated latching assemblies.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of an autonomous robotic system according to an embodiment of the present disclosure; and

FIGS. 2-7 are diagrammatic views of a multi-axis attachment system for use with the autonomous robotic system of FIG. 1 according to an embodiment of the present disclosure.

Like reference symbols in the various drawings indicate like elements.

### DETAILED DESCRIPTION OF THE PREFERRED EMBODIMENTS

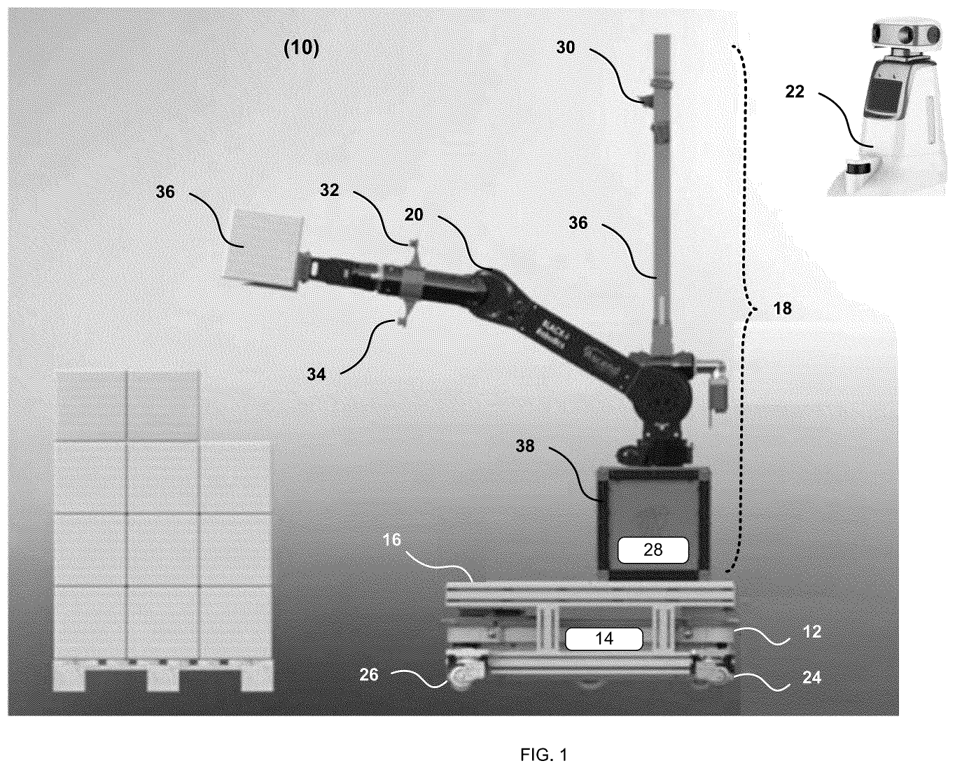

Referring to FIG. 1, there is shown an autonomous robotic system (e.g., autonomous robotic system 10). The autonomous robotic system (e.g., autonomous robotic system 10) may include an autonomous mobile robot (e.g., autonomous mobile robot 12).

An autonomous mobile robot (e.g., autonomous mobile robot 12) is a type of robot designed to perform tasks with high levels of autonomy. These robots can navigate and operate in complex, dynamic environments without continuous human guidance. AMRs are equipped with an array of sensors, processors, and software algorithms that enable them to perceive their surroundings, make decisions, and execute tasks. This capability allows them to autonomously navigate through different terrains and environments, avoiding obstacles, adapting to changes, and completing designated tasks efficiently.

The core technologies enabling AMRs include robotics, artificial intelligence (AI), machine learning, and sensor technology. These robots use sensors such as LiDAR, cameras, GPS, and inertial measurement units to understand and interact with their environment. Advanced AI algorithms process this sensor data, allowing the robot to map its environment, plan paths, and make real-time decisions. Machine learning enables these robots to improve their performance over time based on past experiences and data collected during their operations.

AMRs are employed across various sectors, including logistics and warehousing, manufacturing, healthcare, and agriculture, for tasks such as material handling, delivery, surveillance, and crop monitoring. Their ability to operate autonomously reduces the need for human labor in mundane or dangerous tasks, increases efficiency, and can lead to significant cost savings for businesses. As technology advances, the capabilities and applications of autonomous mobile robots continue to expand, promising to play an increasingly significant role in various industries and aspects of daily life.

The autonomous mobile robot (e.g., autonomous mobile robot 12) may be powered by the primary energy source (e.g., primary energy source 14). Autonomous mobile robot (e.g., autonomous mobile robot 12) may rely on various power sources to operate, examples of which may include but are not limited to battery systems. The choice of battery systems may impact the robot's operational efficiency, runtime, and overall performance.

Some common battery sources (e.g., primary energy source 14) may include:
Lithium-Ion Batteries (Li-ion): These are the most popular choice for AMRs due to their high energy density, which means they can store more energy for their size and weight than other types of batteries. Li-ion batteries also have a relatively long lifecycle, can be charged quickly, and have a low self-discharge rate. Their efficiency and longevity make them suitable for applications requiring long periods of use and minimal downtime.
Nickel-Metal Hydride Batteries (NiMH): Before the widespread adoption of Li-ion technology, NiMH batteries were commonly used in various types of robots. They offer a good balance between cost and performance, with a moderate energy density and a relatively environmentally friendly profile due to the absence of toxic metals. However, they are less favored now due to their heavier weight and lower energy efficiency compared to Li-ion batteries.
Lead-Acid Batteries: Known for their robustness and low cost, lead-acid batteries have been used in larger, industrial-type AMRs, particularly where weight is not a significant issue, and high-power output is required for short durations. They are less energy-efficient and have a shorter lifecycle compared to Li-ion and NiMH batteries, making them less suitable for applications requiring frequent charging and long operational hours.
Lithium Polymer Batteries (LiPo): LiPo batteries offer a higher energy density than Li-ion and can be made in almost any shape or size. They are lightweight and have a high discharge rate, making them ideal for applications needing a quick power supply. However, they can be more expensive and require careful handling and charging practices to prevent issues like swelling and potential fires.
Solid-State Batteries: This is an emerging technology that promises higher energy densities, longer lifecycles, and enhanced safety features over traditional Li-ion batteries. Solid-state batteries use a solid electrolyte instead of a liquid one, potentially reducing the risk of leaks and fires. While not yet widely adopted in AMRs due to current technological and cost barriers, they represent a promising future direction for robot power supplies.

The choice of battery (e.g., primary energy source 14) for an autonomous mobile robot (e.g., autonomous mobile robot 12) depends on various factors, including the specific application requirements, operational environment, expected runtimes, and cost considerations. As battery technology continues to evolve, advancements in energy density, safety, and sustainability can be expected, further expanding the capabilities and applications of autonomous mobile robots (e.g., autonomous mobile robot 12).

The autonomous robotic system (e.g., autonomous robotic system 10) may include a robot accessory mounting cart (e.g., robot accessory mounting cart 16). The robot accessory mounting cart (e.g., robot accessory mounting cart 16) may be configured to receive one or more accessories (e.g., accessories 18) configured to work with the autonomous mobile robot (e.g., autonomous mobile robot 12), wherein examples of such accessories (e.g., accessories 18) may include but are not limited to a robotic arm system (e.g., robotic arm system 20) for lifting/moving objects, and a monitoring system (e.g., monitoring system 22) for monitoring/patrolling space.

The robot accessory mounting cart (e.g., robot accessory mounting cart 16) may include one or more outrigger wheels (e.g., outrigger wheels 24, 26). These outrigger wheels (e.g., outrigger wheels 24, 26) may be configured to serve various purposes, such as partially supporting the weight of the accessories (e.g., accessories 18) attached to the autonomous robotic system (e.g., autonomous robotic system 10) and/or providing additional stability by widening the trackwidth of the autonomous robotic system (e.g., autonomous robotic system 10).

The robotic arm system (e.g., robotic arm system 20) and/or the monitoring system (e.g., monitoring system 22) may be powered by a primary energy source (e.g., primary energy source 28). Examples of such a primary energy source (e.g., primary energy source 28) may include: Lithium-Ion Batteries (Li-ion); Nickel-Metal Hydride Batteries (NiMH); Lead-Acid Batteries; Lithium Polymer Batteries (LiPo); and Solid-State Batteries.

The robotic arm system (e.g., robotic arm system 20) may include machine vision system 30. An example of such a machine vision system (e.g., machine vision system 30) may include but is not limited to the Intel® RealSense™ D455 depth camera. The machine vision system (e.g., machine vision system 30) may be configured to include multiple/additional machine vision systems (e.g., multiple/additional cameras 32, 34). Accordingly, these one or more additional cameras may be positioned along the robotic arm system (e.g., robotic arm system 20). For example, these additional cameras (e.g., multiple/additional cameras 32, 34) may be mounted on the robotic arm system (e.g., robotic arm system 20) and may provide visual target identification for pick-up and/or positioning of e.g., object 36, as well as proximate object detection to allow for safe operation of the robotic arm system (e.g., robotic arm system 20) near moving and stationary objects.

To properly position machine vision system 30 with respect to the robotic arm system (e.g., robotic arm system 20) and/or the autonomous robotic system (e.g., autonomous robotic system 10), machine vision system 30 may be mounted on mast assembly 36 coupled (i.e., directly or indirectly) to the robotic arm system (e.g., robotic arm system 20) and/or the autonomous robotic system (e.g., autonomous robotic system 10). Through the use of mast assembly 36, an elevated point of view may be achieved with respect to the moving parts of the robotic arm system (e.g., robotic arm system 20) and/or the autonomous robotic system (e.g., autonomous robotic system 10), thus providing situational awareness to avoid collision and/or permit safe operation by humans within the reachable proximity of the moving parts of the robotic arm system (e.g., robotic arm system 20) and/or its payload.

The robotic arm system (e.g., robotic arm system 20) may include various operational control systems (e.g., operational control systems 38), examples of which may include but are not limited to electrical control systems, pneumatic control systems, and hydraulic control systems.

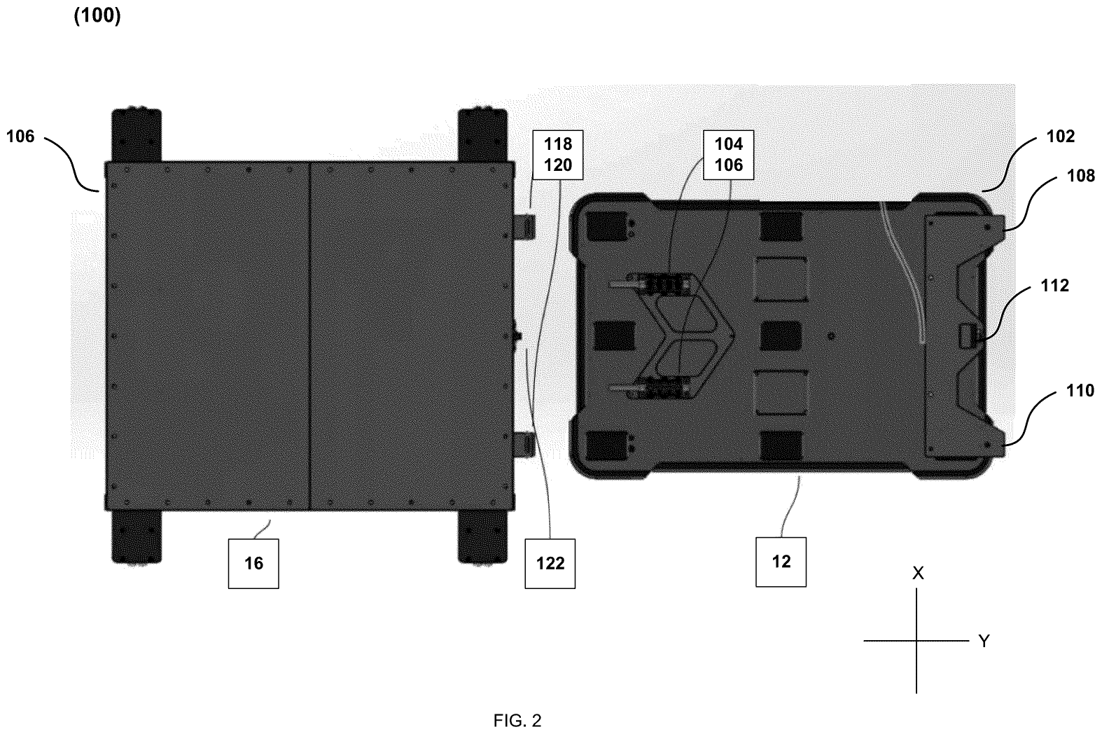

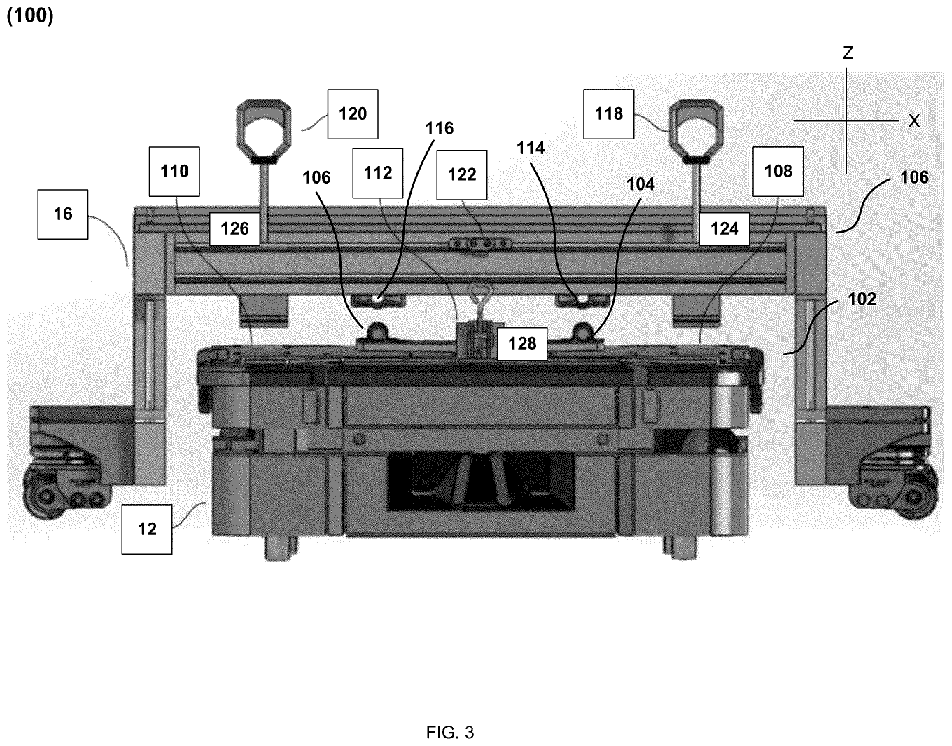

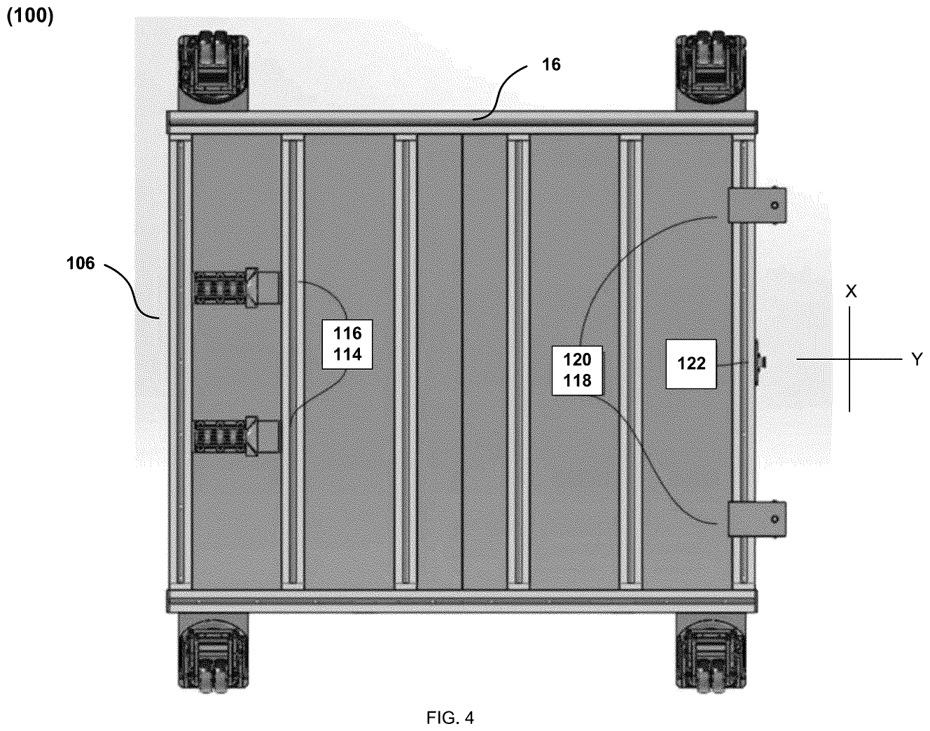

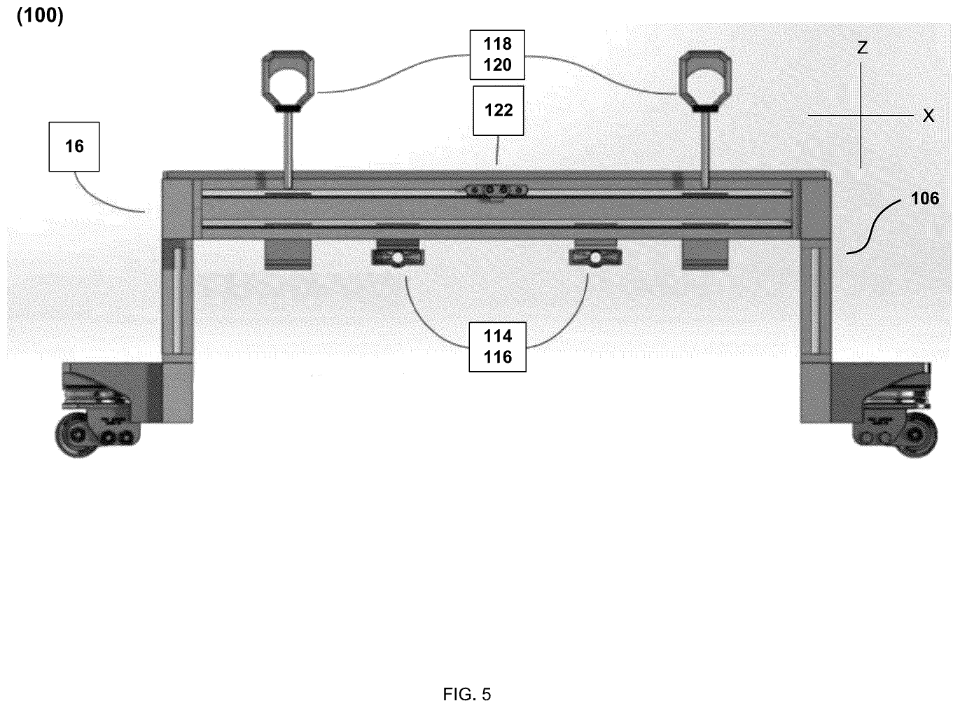

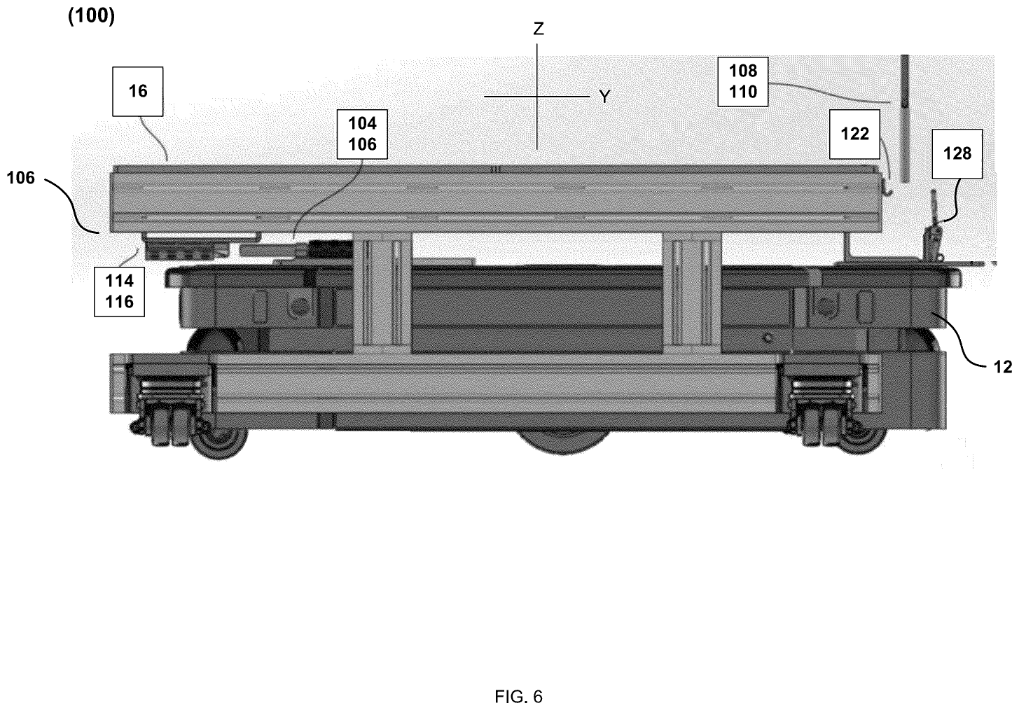

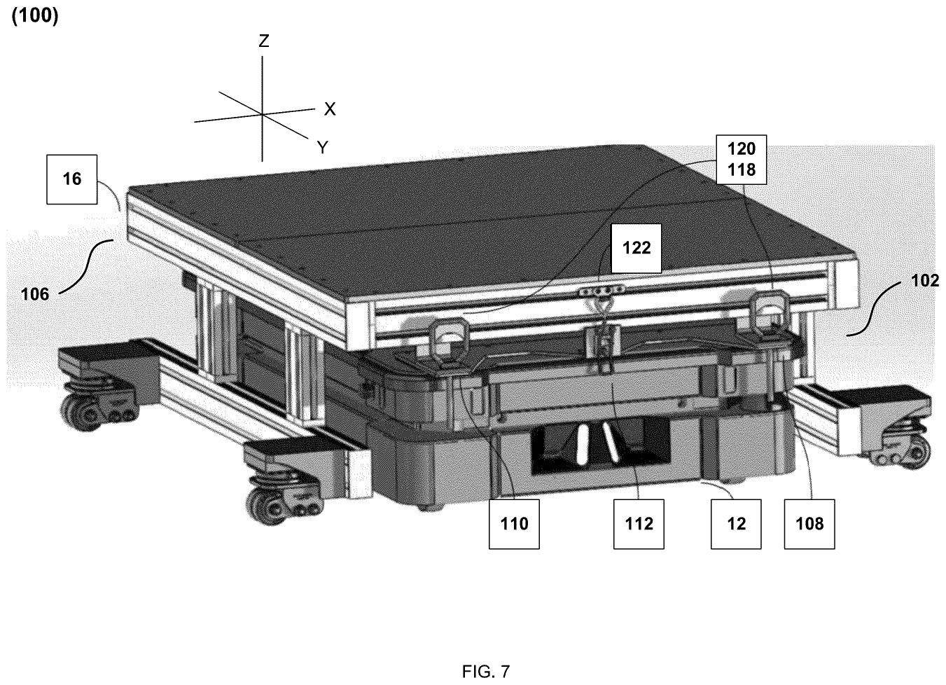

Referring also to FIGS. 2-7, the autonomous robotic system (e.g., autonomous robotic system 10) may include a multi-axis attachment system (e.g., multi-axis attachment system 100).

The multi-axis attachment system (e.g., multi-axis attachment system 100) may include a first attachment subsystem (e.g., first attachment subsystem 102) configured to be coupled to an autonomous mobile robot (e.g., autonomous mobile robot 12) and including one or more primary latching assemblies (e.g., primary latching assemblies 104, 106, 108, 110, 112).

The multi-axis attachment system (e.g., multi-axis attachment system 100) may include a second attachment subsystem (e.g., second attachment subsystem 106) configured to be coupled to a robot accessory mounting cart (e.g., robot accessory mounting cart 16) and including one or more secondary latching assemblies (e.g., secondary latching assemblies 114, 116, 118, 120, 122).

The one or more secondary latching assemblies (e.g., secondary latching assemblies 114, 116, 118, 120, 122) may be configured to releasably engage the one or more primary latching assemblies (e.g., primary latching assemblies 104, 106, 108, 110, 112) to effectuate the three-axis releasable coupling of the robot accessory mounting cart (e.g., robot accessory mounting cart 16) and the autonomous mobile robot (e.g., autonomous mobile robot 12).

The primary latching assemblies (e.g., primary latching assemblies 104, 106, 108, 110, 112) and/or the secondary latching assemblies (e.g., secondary latching assemblies 114, 116, 118, 120, 122) may include one or more female latching receptacles (e.g., female latching receptacles 114, 116) configured to receive one or more male latching appendages (e.g., male latching appendages 104, 106).

Additionally/alternatively, the primary latching assemblies (e.g., primary latching assemblies 104, 106, 108, 110, 112) and/or the secondary latching assemblies (e.g., secondary latching assemblies 114, 116, 118, 120, 122) may include one or more male latching appendages (e.g., male latching appendages 104, 106) configured to be positioned within the one or more female latching receptacles (e.g., female latching receptacles 114, 116).

Regardless of the exact position, the autonomous mobile robot (e.g., autonomous mobile robot 12) may navigate under the robot accessory mounting cart (e.g., robot accessory mounting cart 16) to insert the male latching appendages (e.g., male latching appendages 104, 106) into the female latching receptacles (e.g., female latching receptacles 114, 116). For example, the autonomous mobile robot (e.g., autonomous mobile robot 12) may enter and attach the robot accessory mounting cart (e.g., robot accessory mounting cart 16) from the rear and detach the robot accessory mounting cart (e.g., robot accessory mounting cart 16) in a reverse manner (i.e., by backing out), thus avoiding the need to physically lift robot accessory mounting cart 16 and its payload onto the autonomous mobile robot (e.g., autonomous mobile robot 12).

The primary latching assemblies (e.g., primary latching assemblies 104, 106, 108, 110, 112) and/or the secondary latching assemblies (e.g., secondary latching assemblies 114, 116, 118, 120, 122) may include one or more manually-operated latching assemblies (e.g., manually-operated latching assemblies 108, 110, 112. 118, 120, 122). For example:
Primary latching assembly 104 may be manually latched/coupled with secondary latching assembly 114 by e.g., inserting a male pin of one of the latching assemblies into a female receptacle of another of the latching assemblies via the maneuvering of autonomous mobile robot 12 beneath robot accessory mounting cart 16:
Primary latching assembly 106 may be manually latched/coupled with secondary latching assembly 116 by e.g., inserting a male pin of one of the latching assemblies into a female receptacle of another of the latching assemblies via the maneuvering of autonomous mobile robot 12 beneath robot accessory mounting cart 16:
Secondary latching assembly 118 may be manually pushed downward to be latched/coupled to primary latching assembly 108, wherein the lower portion of secondary latching assembly 118 may grasp primary latching assembly 108:
Secondary latching assembly 120 may be manually pushed downward to be latched/coupled to primary latching assembly 110, wherein the lower portion of secondary latching assembly 120 may grasp primary latching assembly 110: and
Primary latching assembly 112 may be manually rotated upward to latch/couple with secondary latching assembly 122, wherein primary latching assembly 112 may be in the form of a hasp that engages pin-shaped secondary latching assembly 122.

Additionally/alternatively, the primary latching assemblies (e.g., primary latching assemblies 104, 106, 108, 110, 112) and/or the secondary latching assemblies (e.g., secondary latching assemblies 114, 116, 118, 120, 122) may include one or more automatically-operated latching assemblies (e.g., manually-operated latching assemblies 108, 110, 112. 118, 120, 122).

For example:
Secondary latching assembly 118 may be automatically pushed downward (via actuator 124) to be latched/coupled to primary latching assembly 108, wherein the lower portion of secondary latching assembly 118 may grasp primary latching assembly 108:
Secondary latching assembly 120 may be automatically pushed downward (via actuator 126) to be latched/coupled to primary latching assembly 110, wherein the lower portion of secondary latching assembly 120 may grasp primary latching assembly 110: and
Primary latching assembly 112 may be automatically rotated upward (via actuator 128) to latch/couple with secondary latching assembly 122, wherein primary latching assembly 112 may be in the form of a hasp that engages pin-shaped secondary latching assembly 122.

Generally speaking, the multi-axis attachment system (e.g., multi-axis attachment system 100) may be configured to locate the robot accessory mounting cart (e.g., robot accessory mounting cart 16) on top of the autonomous mobile robot (e.g., autonomous mobile robot 12) in the XY-plane. For example, the multi-axis attachment system (e.g., multi-axis attachment system 100) may be configured to prevent left-right/fore -aft movement of the robot accessory mounting cart (e.g., robot accessory mounting cart 16) with respect to the autonomous mobile robot (e.g., autonomous mobile robot 12) by locking the robot accessory mounting cart (e.g., robot accessory mounting cart 16) on top of the autonomous mobile robot (e.g., autonomous mobile robot 12). Such a configuration results in the robot accessory mounting cart (e.g., robot accessory mounting cart 16) and the autonomous mobile robot (e.g., autonomous mobile robot 12) moving in unison on the surface on which the autonomous robotic system (e.g., autonomous robotic system 10) is moving/operating.

Further, the multi-axis attachment system (e.g., multi-axis attachment system 100) may be configured to lock the robot accessory mounting cart (e.g., robot accessory mounting cart 16) on top of the autonomous mobile robot (e.g., autonomous mobile robot 12) in the Z-axis. For example, the multi-axis attachment system (e.g., multi-axis attachment system 100) may be configured to prevent up-down movement of the robot accessory mounting cart (e.g., robot accessory mounting cart 16) with respect to the autonomous mobile robot (e.g., autonomous mobile robot 12) by locking the robot accessory mounting cart (e.g., robot accessory mounting cart 16) on top of the autonomous mobile robot (e.g., autonomous mobile robot 12). Such a configuration prevents the robot accessory mounting cart (e.g., robot accessory mounting cart 16) from lifting/tipping off of the autonomous mobile robot (e.g., autonomous mobile robot 12) due to e.g., the robotic arm system (e.g., robotic arm system 20) lifting an object (e.g., object 36) that creates a moment about the mounting point of robotic arm system 20 on robot accessory mounting cart 16.

### General

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block or blocks.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A multi-axis attachment system comprising:
a first attachment subsystem configured to be coupled to an autonomous mobile robot and including one or more primary latching assemblies; and
a second attachment subsystem configured to be coupled to a robot accessory mounting cart and including one or more secondary latching assemblies;
wherein the one or more secondary latching assemblies are configured to releasably engage the one or more primary latching assemblies to effectuate the three-axis releasable coupling of the robot accessory mounting cart and the autonomous mobile robot.

2. The multi-axis attachment system of claim 1 wherein the robot accessory mounting cart is configured to receive one or more accessories configured to work with the autonomous mobile robot.

3. The multi-axis attachment system of claim 2 wherein the one or more accessories includes a robotic arm assembly.

4. The multi-axis attachment system of claim 2 wherein the one or more accessories includes a monitoring system.

5. The multi-axis attachment system of claim 1 wherein the robot accessory mounting cart includes one or more outrigger wheels.

6. The multi-axis attachment system of claim 1 wherein the primary latching assemblies and/or the secondary latching assemblies include one or more female latching receptacles configured to receive one or more male latching appendages.

7. The multi-axis attachment system of claim 6 wherein the primary latching assemblies and/or the secondary latching assemblies include one or more male latching appendages configured to be positioned within the one or more female latching receptacles.

8. The multi-axis attachment system of claim 1 wherein the primary latching assemblies and/or the secondary latching assemblies include one or more manually-operated latching assemblies.

9. The multi-axis attachment system of claim 1 wherein the primary latching assemblies and/or the secondary latching assemblies include one or more automatically-operated latching assemblies.

10. The multi-axis attachment system of claim 1 wherein the multi-axis attachment system is configured to locate the robot accessory mounting cart on top of the autonomous mobile robot in the XY-plane.

11. The multi-axis attachment system of claim 1 wherein the multi-axis attachment system is configured to lock the robot accessory mounting cart on top of the autonomous mobile robot in the X-axis.

12. A multi-axis attachment system comprising:
a first attachment subsystem configured to be coupled to an autonomous mobile robot and including one or more primary latching assemblies; and
a second attachment subsystem configured to be coupled to a robot accessory mounting cart and including one or more secondary latching assemblies;
wherein:
the one or more secondary latching assemblies are configured to releasably engage the one or more primary latching assemblies to effectuate the three-axis releasable coupling of the robot accessory mounting cart and the autonomous mobile robot, and
the robot accessory mounting cart is configured to receive one or more accessories configured to work with the autonomous mobile robot.

13. The multi-axis attachment system of claim 12 wherein the one or more accessories includes a robotic arm assembly.

14. The multi-axis attachment system of claim 12 wherein the one or more accessories includes a monitoring system.

15. The multi-axis attachment system of claim 12 wherein the robot accessory mounting cart includes one or more outrigger wheels.

16. The multi-axis attachment system of claim 12 wherein the primary latching assemblies and/or the secondary latching assemblies include one or more female latching receptacles configured to receive one or more male latching appendages.

17. The multi-axis attachment system of claim 16 wherein the primary latching assemblies and/or the secondary latching assemblies include one or more male latching appendages configured to be positioned within the one or more female latching receptacles.

18. A multi-axis attachment system comprising:
a first attachment subsystem configured to be coupled to an autonomous mobile robot and including one or more primary latching assemblies; and
a second attachment subsystem configured to be coupled to a robot accessory mounting cart and including one or more secondary latching assemblies;
wherein:
the multi-axis attachment system is configured to locate the robot accessory mounting cart on top of the autonomous mobile robot in the XY-plane, and
the multi-axis attachment system is configured to lock the robot accessory mounting cart on top of the autonomous mobile robot in the X-axis.

19. The multi-axis attachment system of claim 18 wherein the robot accessory mounting cart is configured to receive one or more accessories configured to work with the autonomous mobile robot.

20. The multi-axis attachment system of claim 19 wherein the one or more accessories includes a robotic arm assembly.

21. The multi-axis attachment system of claim 19 wherein the one or more accessories includes a monitoring system.

22. The multi-axis attachment system of claim 18 wherein the primary latching assemblies and/or the secondary latching assemblies include one or more manually-operated latching assemblies.

23. The multi-axis attachment system of claim 18 wherein the primary latching assemblies and/or the secondary latching assemblies include one or more automatically-operated latching assemblies.
